(19) United States
(12) Patent Application Publication
(10) Pub. No.: US 2012/0244732 A1
(43) Pub. Date: Sep. 27, 2012

(54) ELECTRICAL ADAPTER SYSTEM

(75) Inventors: Larry W. Fullerton, New Hope, AL (US); Mark D. Roberts, Huntsville, AL (US)

(73) Assignee: Correlated Magnetics Research, LLC., Huntsville, AL (US)

(21) Appl. No.: 13/430,219

(22) Filed: Mar. 26, 2012

Related U.S. Application Data
(60) Provisional application No. 61/465,801, filed on Mar. 24, 2011.

(51) Int. Cl. H01R 33/08

(52) U.S. Cl. 439/236

(57) ABSTRACT

An electrical adapter, the adapter including an Edison screw base configured to receive a primary voltage from a voltage source, a voltage converter circuit configured to convert the primary voltage to the secondary voltage, and a first electrical connector part configured to be detachably coupled to a second electrical connector part of an electrical fixture configured to be powered by the secondary voltage.

### CROSS-REFERENCE TO RELATED APPLICATIONS

This patent application claims the priority benefit of U.S. Provisional Application No. 61,465,801 filed Mar. 24, 2011, which is incorporated herein by reference in its entirety.

### FIELD OF THE INVENTION

The present invention relates generally to an electrical adapter system. More particularly, the present invention relates to an electrical adapter system including an electrical adapter for connecting to an electrical fixture.

### BRIEF DESCRIPTION OF THE DRAWINGS

The present invention is described with reference to the accompanying drawings. In the drawings, like reference numbers indicate identical or functionally similar elements. Additionally, the left-most digit(s) of a reference number identifies the drawing in which the reference number first appears.

FIG. 1A depicts an exemplary Edison screw light bulb socket and an exemplary Edison screw light bulb;

FIG. 1B depicts an exemplary electrical adapter system in accordance with the present invention comprising an electrical adapter and an exemplary electrical fixture;

FIG. 1C depicts an exemplary electrical outlet;

FIG. 1D depicts a front view of an exemplary multi-part electrical system in accordance with the present invention;

FIG. 1E depicts a back view of the exemplary electrical adapter system of FIG. 1D;

FIG. 1F depicts a front view of another exemplary electrical adapter system in accordance with the present invention;

FIG. 1G depicts a front view of yet another exemplary electrical adapter system in accordance with the present invention;

FIG. 1H depicts a back view of the exemplary electrical adapter system of FIG. 1G;

FIG. 1I depicts a front view of still another exemplary electrical adapter system in accordance with the present invention that includes a stackable adapter;

FIG. 1J depicts a back view of the exemplary electrical adapter system of FIG. 1I;

FIG. 2A depicts two exemplary components of a correlated magnetic electrical connector used to magnetically attach and electrically connect the electrical adapter and electrical fixture of an electrical adapter system in accordance with the present invention;

FIG. 2B depicts another two exemplary parts of a correlated magnetic electrical connector used to attach the parts of a electrical adapter system in accordance with the present invention;

FIG. 2C depicts yet another two exemplary components of a correlated magnetic electrical connector used to attach the parts of a electrical adapter system in accordance with the present invention;

FIG. 2D depicts an exemplary stackable adapter that can be used with the two exemplary components of the correlated magnetic electrical connector of FIG. 2A;

FIG. 2E depicts an exemplary stackable adapter that can be used with the two exemplary components of the correlated magnetic electrical connector of FIG. 2B;

FIG. 2F depicts an exemplary stackable adapter that can be used with the two exemplary components of the correlated magnetic electrical connector of FIG. 2C;

FIG. 3A depicts exemplary ring-shaped electrical contact portions and exemplary circularly-shaped correlated magnetic structure portions of two exemplary components of a correlated magnetic electrical connector in accordance with the present invention;

FIG. 3B depicts exemplary circularly-shaped electrical contact portions and exemplary ring-shaped correlated magnetic structure portions of two exemplary components of a correlated magnetic electrical connector in accordance with the present invention;

FIG. 3C depicts exemplary ring-shaped electrical contact portions and exemplary circularly-shaped and ring-shaped correlated magnetic structure portions of two exemplary components of a correlated magnetic electrical connector in accordance with the present invention;

FIG. 3D depicts exemplary ring-shaped and circularly-shaped electrical contact portions and exemplary ring-shaped correlated magnetic structure portions of two exemplary components of a correlated magnetic electrical connector in accordance with the present invention;

FIG. 4A depicts exemplary electrical contacts of exemplary ring-shaped electrical portions of two exemplary components of a correlated magnetic electrical connector in accordance with the present invention;

FIG. 4B depicts exemplary electrical contacts of exemplary circularly-shaped electrical portions of two exemplary components of a correlated magnetic electrical connector in accordance with the present invention;

FIG. 5A depicts exemplary circularly-shaped complementary correlated magnetic structure portions of two exemplary components of a correlated magnetic electrical connector in accordance with the present invention;

FIG. 5B depicts exemplary ring-shaped complementary correlated magnetic structure portions of two exemplary components of a correlated magnetic electrical connector in accordance with the present invention;

FIG. 5C depicts another exemplary circularly-shaped multi-level correlated magnetic structure portions of two exemplary components of a correlated magnetic electrical connector in accordance with the present invention; and

FIG. 5D depicts exemplary ring-shaped multi-level correlated magnetic structure portions of two exemplary components of a correlated magnetic electrical connector in accordance with the present invention.

### DETAILED DESCRIPTION OF THE INVENTION

The present invention will now be described more fully in detail with reference to the accompanying drawings, in which the preferred embodiments of the invention are shown. This invention should not, however, be construed as limited to the embodiments set forth herein; rather, they are provided so that this disclosure will be thorough and complete and will fully convey the scope of the invention to those skilled in the art.

The present invention provides an electrical adapter system. It involves magnetic techniques related to those described in U.S. Pat. No. 7,800,471, issued Sep. 21, 2010, U.S. patent application Ser. No. 12/358,423, filed Jan. 23, 2009, U.S. patent application Ser. No. 12/476,952, filed Jun. 2, 2009, and U.S. patent application Ser. No. 12/885,450, filed Sep. 18, 2010, which are all incorporated herein by reference in their entirety. The present invention may be applicable to systems and methods described in U.S. Pat. No. 7,681,256, issued Mar. 23, 2010, U.S. Pat. No. 7,750,781, issued Jul. 6, 2010, U.S. Pat. No. 7,755,462, issued Jul. 13, 2010, U.S. Pat. No. 7,812,698, issued Oct. 12, 2010, U.S. Pat. Nos. 7,817,002, 7,817,003, 7,817,004, 7,817,005, and 7,817,006, issued Oct. 19, 2010, U.S. Pat. No. 7,821,367, issued Oct. 26, 2010, U.S. Pat. Nos. 7,823,300 and 7,824,083, issued Nov. 2, 2010, U.S. Pat. No. 7,839,247, issued Nov. 23, 2010, and U.S. Pat. Nos. 7,843,295, 7,843,296, and 7,843,297, issued Nov. 30, 2010, and U.S. patent application Ser. No. 12/322,561, filed Feb. 4, 2009, U.S. patent application Ser. No. 12/479,821, filed Jun. 7, 2009, U.S. patent application Ser. No. 12/496,463, filed Jul. 1, 2009, U.S. patent application Ser. No. 12/499,039, filed Jul. 7, 2009, U.S. patent application Ser. No. 12/783,409, filed Jun. 19, 2010, U.S. patent applications Ser. Nos. 12/894,937, 12/895,061, and 12/895,589, filed Sep. 30, 2010, and U.S. patent applications Ser. Nos. 12/896,383, 12/896,424, 12/896,453, and 12/896,723, filed Oct. 1, 2010, which are all incorporated by reference herein in their entirety. The invention may also incorporate techniques described in U.S. Provisional Patent Application 61/403,814, filed Sep. 22, 2010, U.S. Provisional Patent Application 61/455,820, filed Oct. 27, 2010, U.S. Provisional Patent Application 61/459,329, filed Dec. 10, 2010, U.S. Provisional Patent Application 61/459,994, filed Dec. 22, 2010, U.S. Provisional Patent Application 61/461,570, filed Jan. 21, 2011, and U.S. Provisional Patent Application filed Feb. 7, 2011, titled “A System and Method for Producing Magnetic Structures”, Docket Number CRR-0007/CIP40-P, which are all incorporated by reference herein in their entirety.

In accordance with one embodiment of the invention, an electrical adapter system comprises an electrical adapter and an electrical fixture. The electrical adapter provides an electrical connection to an Edison screw socket. The electrical adapter includes an Edison screw base, a voltage converter circuit, and a first electrical connector part.

The Edison screw base is configured to receive a primary voltage from a voltage source. The adapter receives the primary voltage, for example 120 VAC, from an Edison screw light bulb socket and converts the primary voltage using the voltage converter circuit as required to supply a secondary, typically lower, and optionally variable voltage required by the electrical fixture.

Voltage converter circuit is configured to convert the primary voltage to the secondary voltage. The voltage converter circuit may be a switched mode power supply such as a buck converter.

The first electrical connector part is configured to be detachably coupled to a second electrical connector part of an electrical fixture configured to be powered by the secondary voltage. The first electrical connector part and second electrical connector part form a two part correlated magnetic electrical connector connecting the electrical adapter and electrical fixture.

Under one arrangement, the two parts of the correlated magnetic electrical connector to have a fixed position when magnetically aligned. For example, the two parts are fixed (i.e., unable to move) within the electrical adapter and electrical fixtures. In another arrangement, at least one of the two parts of the correlated magnetic electrical connector can move within a bounded area(s) within the electrical adapter and/or the electrical fixture. A moveable part of the correlated magnetic electrical connector may be located to a position and then held in that position by a lock, which may be some mechanical means such as a set screw. Generally, any of various well known mechanical means can to “lock” and “unlock” a connector in accordance with the invention.

In an exemplary embodiment, the electrical adapter comprises a driver circuit and the electrical fixture comprises a light emitting diode (LED) lamp, where the driver circuit can provide a variable secondary voltage enabling control over the LED lamp brightness and power consumption.

In another embodiment, an electrical fixture and/or an electrical adapter (or stackable adapter) may comprise one or more of an audio input device (e.g., a microphone), an audio output device (e.g., a speaker), a video input device (e.g., a movie camera), a video output device (e.g., a display), a radar (e.g., an ultra wideband radar), an environment sensor (e.g., a temperature, moisture, carbon dioxide, radon, smoke, or other sensor), a network communications device (e.g., a communications repeater device, a network router, or a communications portal), a security sensor (e.g., a motion sensor, infrared sensor, optical sensor, or other sensor), a light fixture (e.g., Christmas tree lights), a timer device, a remote control repeater device, or a rechargeable battery (e.g., to enable emergency lighting).

In a further embodiment, an electrical fixture and/or an electrical adapter (or stackable adapter) may function as part of a communication system, a person/object/animal tracking system, a security system, an environment control system, a environment monitoring system, a gaming system, an automation system, or a media (e.g., audio, video) delivery system. For example, an electrical adapter could include Blue Tooth or WiFi communications capabilities.

Under one arrangement, an electrical fixture and/or an electrical adapter (or stackable adapter) comprises at least one of a transponder, a transmitter, a receiver, or an antenna. Under another arrangement, an electrical adapter conveys communications signals via a wiring infrastructure to which an electrical outlet or an electrical fixture having an Edison screw light bulb socket is interfaced or otherwise connected. Under still another arrangement, an electrical adapter conveys tracking signals (e.g., time-domain reflectometry signals) via such a wiring infrastructure.

The magnetic sources employed in the invention may be permanent magnetic sources, electromagnets, electro-permanent magnets, or combinations thereof. Magnetic sources may be discrete magnets or may be printed into magnetizable material.

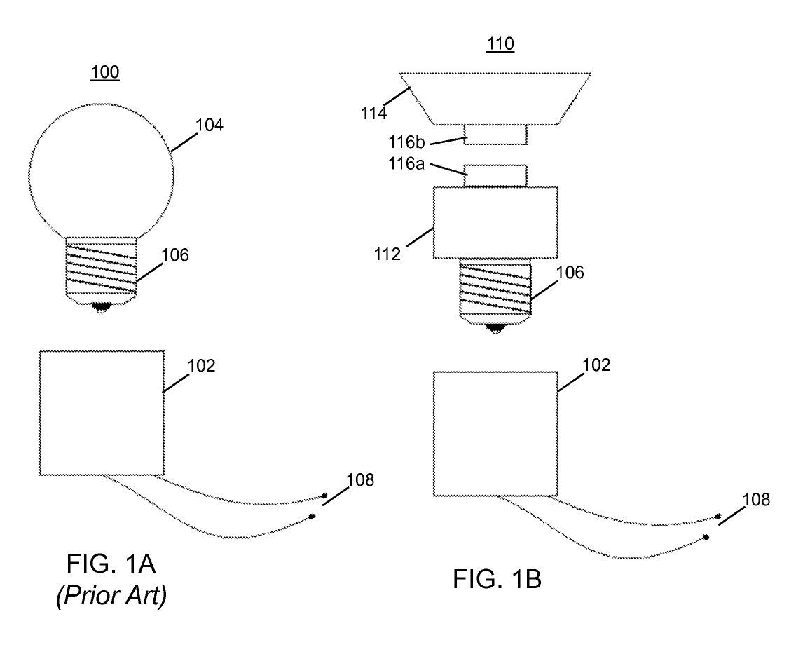

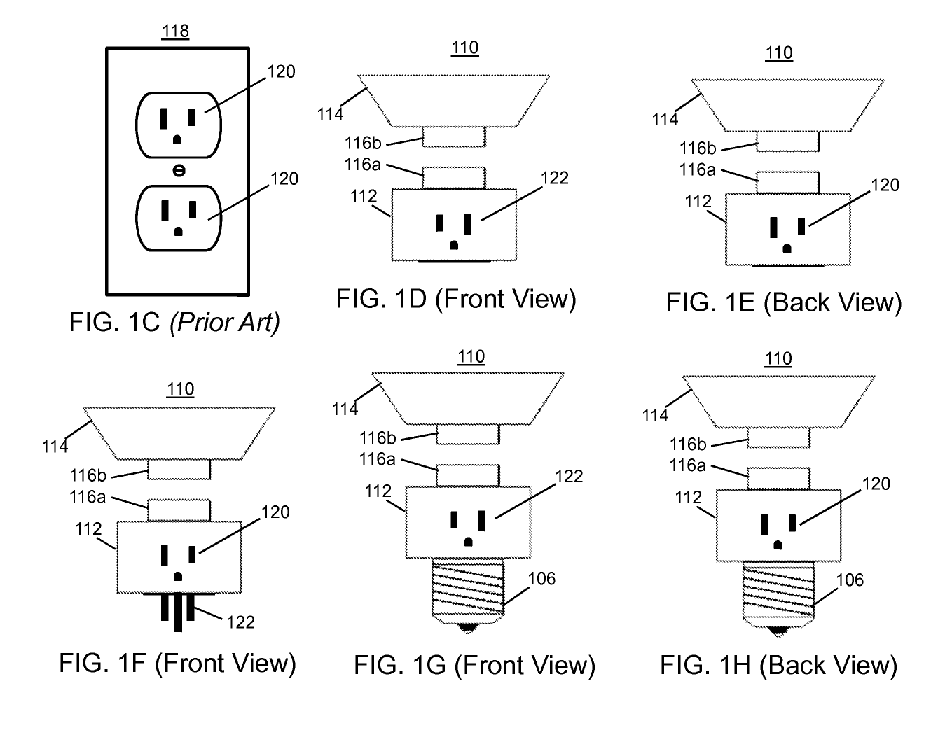

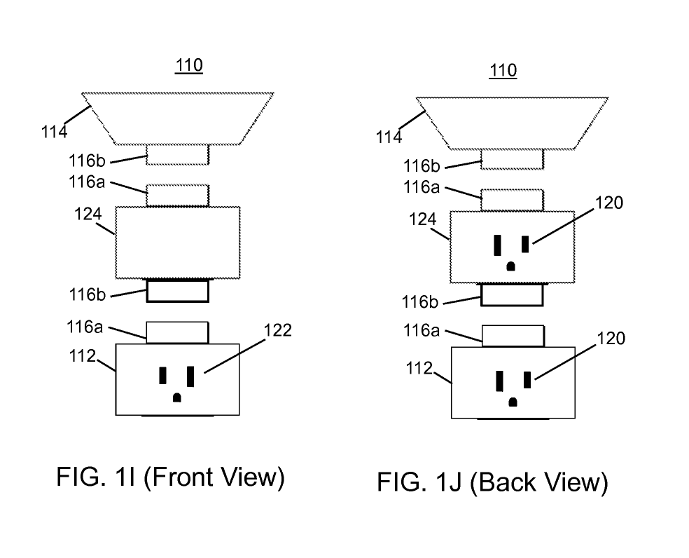

FIG. 1A depicts an exemplary Edison screw light bulb socket 102 and an exemplary Edison screw light bulb 100. The Edison screw light bulb 100 comprises a glass bulb portion 104 and an electrical male Edison screw base portion 106 that includes an electrical contact for receiving a voltage when placed (screwed) into the Edison screw light bulb socket 102. The electrical contact provides the voltage to a filament (not shown) inside the glass bulb portion 104 causing the light bulb 100 to produce light. The Edison screw light bulb socket 102 receives a voltage 108 from a primary voltage source, for example, a 120 VAC voltage source. One skilled in the art will recognize that all sorts of Edison screw light bulb sockets 102 exist for use in the United States and/or in other countries that receive different voltages (e.g., 240 VAC).

FIG. 1B depicts an exemplary electrical adapter system 110 in accordance with the present invention comprising an electrical adapter 112 and an exemplary electrical fixture 114. The electrical adapter 112 and electrical fixture 114 are connected physically and electrically using a first electrical connector part 116a and a second electrical connector part 116b. One skilled in the art will recognize that the electrical connection between the first and second electrical connector parts 116a 116b could be implemented using a plug and socket approach, an Edison screw socket approach, or any other electrical connector approach, whereby wiring, contacts, plugs, and sockets are not shown. Additionally, the shapes of the electrical adapter 112 and the electrical fixture 114 were arbitrarily chosen and can be shaped and sized as appropriate. Furthermore, although a single electrical fixture 114 is shown being attachable to an electrical adapter 112, two or more electrical fixtures 114 could be attachable to a single electrical adapter 112 having multiple first electrical connector parts 116a (not shown), where the driver circuitry of the electrical adapter could be configured to supply the same (or different) types of secondary voltage types as required to support the same (or different) voltage requirements of multiple electrical fixtures 114.

FIG. 1C depicts an exemplary electrical outlet 118 having two electrical sockets 120 for receiving electrical plugs (not shown) such as can be found on power cords for common electrical fixtures and electrical appliances including table lamps, televisions, computers, toasters, vacuum cleaners, and the like. One skilled in the art will recognize that the electrical outlet 118 could be a 120 VAC voltage source or any other voltage source available in the United States and/or in other countries (e.g., 240 VAC) and can conform to any of the many well known plug standards including Type A, Type B, Type C, Type D, Type E, Type F, Type E/F hybrid, Type G, Type H, Type I, Type J, Type K, Type L, Type M, or any other desired type.

FIG. 1D depicts a front view of an exemplary electrical adapter system 110 in accordance with the present invention. Instead of an Edison screw light bulb socket 102, the electrical adapter system 110 has a plug 122 able to connect into one of the electrical sockets 120 of the electrical outlet 118 of FIG. 1C.

FIG. 1E depicts a back view of the exemplary electrical adapter system 110 of FIG. 1D, which includes an optional electrical socket 120 enabling a person to connect the electrical adapter system 110 into an electrical socket 120 of an electrical outlet 118 while still providing an electrical socket 120 for receiving a plug such as a power cord for a vacuum cleaner. The electrical socket 120 outputs a voltage based on the primary voltage. For example, the electrical socket 120 may output a voltage with the same voltage as the primary voltage. The optional electrical socket 120 also enables two or more electrical adapter systems 110 to be daisy-chained to an electrical outlet 118. As such, multiple (perhaps different) electrical fixtures can be powered by a single electrical outlet 118.

FIG. 1F depicts a front view of another exemplary electrical adapter system 110 in accordance with the present invention, which is like the electrical adapter system 110 of FIGS. 1D and 1E except the plug 122 is on the bottom of the electrical adapter 112.

FIG. 1G depicts a front view of yet another exemplary electrical adapter system 110 in accordance with the present invention. As shown, the electrical adapter system 110 includes an electrical male Edison screw base portion 106 and an electrical plug 122 enabling the electrical adapter system 110 to be connected to either an Edison light bulb socket 102 or an electrical outlet 118.

FIG. 1H depicts a back view of the exemplary electrical adapter system 110 of FIG. 1G. As shown, the exemplary electrical adapter system 110 includes an optional electrical socket 120 enabling a plug of a device to be connected and/or enables daisy-chaining of multiple electrical adapter systems 110.

FIG. 1I depicts a front view of still another exemplary electrical adapter system 110 in accordance with the present invention that includes a stackable adapter 124. The first electrical connector part is configured to be detachably coupled to the stackable adapter 124. The stackable adapter 124 includes a third electrical connector part configured to be detachably coupled to the first electrical connector part of the electrical adapter and a fourth electrical connector part configured to be detachably coupled to the second electrical connector part of the electrical fixture. The third electrical connector part of the stackable adapter 124 may be identical to the second electrical connector part of the electrical fixture 114. The fourth electrical connector part of the stackable adapter 124 may be identical to the first electrical connector part of the electrical adapter 112.

The stackable adapter 124 is configured to reside between an electrical adapter 112 configured with an electrical plug 122 for connection into an electrical outlet. Alternatively, a stackable adapter 124 can be configured to reside between an electrical adapter 112 configured with an electrical male Edison screw base portion 106 enabling the electrical adapter system 110 to be connected to either an Edison light bulb socket 102. As described in relation to FIGS. 1G and 1H the stackable adapter 124 could be configured to reside between an electrical adapter configured to connect to an electrical outlet 118 or to an Edison light bulb socket 102. Moreover, multiple stackable adapters 120 can be placed between an electrical adapter 112 and an electrical fixture 114.

FIG. 1J depicts a back view of the exemplary electrical adapter system 110 of FIG. 1I having a stackable electrical adapter 124, where both adapters 112 124 include an optional electrical socket 120. One skilled in the art will recognize that all sorts of combinations of electrical adapters 112, stackable adapters 124, and electrical fixtures 114 are possible as configured using various combinations of electrical sockets 120, electrical plugs 122, and electrical male Edison screw base portions 106.

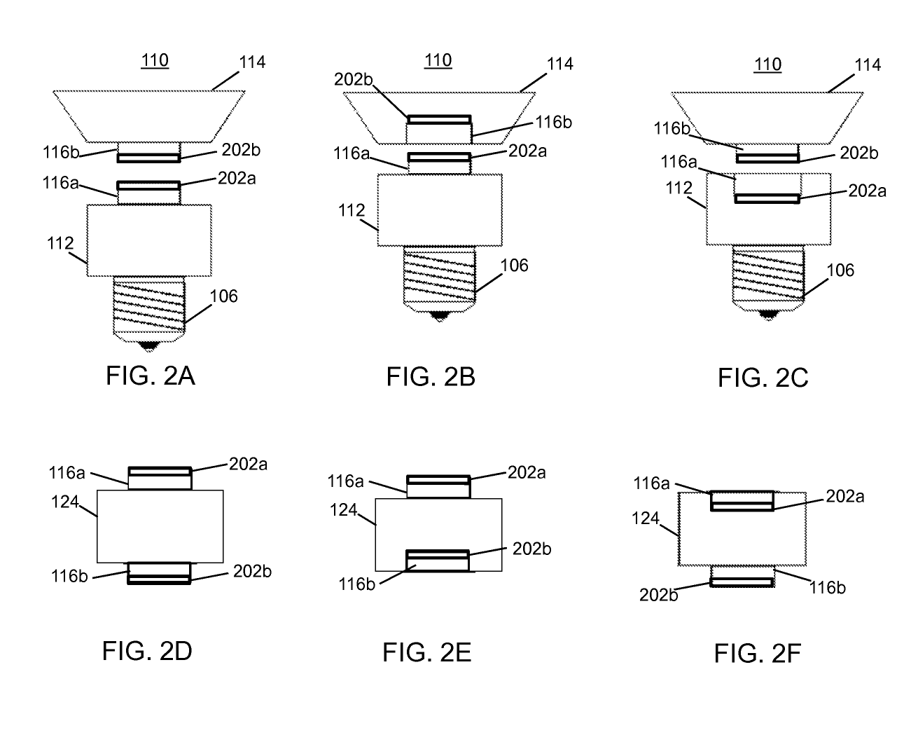

FIG. 2A depicts two exemplary components 202a 202b of a correlated magnetic electrical connector used to magnetically attach and electrically connect the electrical adapter 112 and electrical fixture 114 of an electrical adapter system 110 in accordance with the present invention. As shown in FIG. 2A, the first electrical connector part 116a comprises a first correlated magnetic electrical connector component 202a and the second electrical connector part 116b comprises a second correlated magnetic electrical connector component 202b. As such, the first and second electrical connector parts 116a 116b serve as housings for and include electrical wiring/circuitry connecting to the respective first and second correlated magnetic electrical connector components 202a 202b. The first and second correlated magnetic electrical connector components 202a 202b are configured at or near the surface of the first and second electrical connector parts 116a 116b enabling them to be magnetically attached by aligning the first and second correlated magnetic electrical connector components 202a 202b using sideways translational movement. Once the first and second correlated magnetics connector components 202a 202b are magnetically attached, the electrical adapter 112 and the electrical fixture 114 of the electrical adapter system 110 are electrically connected.

FIG. 2B depicts another two exemplary components 202a 202b of a correlated magnetic electrical connector used to magnetically attach and electrically connect the electrical adapter 112 and electrical fixture 114 of an electrical adapter system 110 in accordance with the present invention. As shown in FIG. 2B, the second electrical connector part 116b and second correlated magnetic electrical connector 202b are recessed into the electrical fixture 114 to serve as a female portion of a male-female connector, whereby the first electrical connector part 116a and first correlated magnetic electrical connector 202a serve as the male portion of the male-female connector. Electrical wiring attached to the second correlated magnetic electrical connector 202b could reside in the electrical fixture 114 and could reside in the second electrical connector part 116b or the second electrical connector part 116b could merely act as a housing in which the second correlated magnetic electrical connector 202b resides and within which the first electrical connector part 116a and first correlated magnetic electrical connector 202a are inserted. One skilled in the art will recognized that the male-female connector approach prevents the use of sideways translational movement and instead requires up and down translational movement and (optionally) rotational movement.

FIG. 2C depicts yet another two exemplary components 202a 202b of a correlated magnetic electrical connector used to attach the electrical adapter 112 and electrical fixture 114 of an electrical adapter system 110 in accordance with the present invention. As shown in FIG. 2C, the first electrical connector part 116a and second correlated magnetic electrical connector 202a are recessed into the electrical adapter 112 to serve as a female portion of a male-female connector, whereby the second electrical connector part 116b and second correlated magnetic electrical connector 202b serve as the male portion of the male-female connector. Electrical wiring attached to the first correlated magnetic electrical connector 202a could reside in the electrical adapter 112 and could reside in the first electrical connector part 116a or the first electrical connector part 116a could merely act as a housing in which the first correlated magnetic electrical connector 202a resides and within which the second electrical connector part 116b and second correlated magnetic electrical connector 202b are inserted.

FIG. 2D depicts an exemplary stackable adapter 124 that can be used with the two exemplary components 202a 202b of the correlated magnetic electrical connector of FIG. 2A. As shown in FIG. 2D, the first component 202a of the correlated magnetic electrical connector of the exemplary stackable adapter 124 can connect to the second component 202b of the correlated magnetic electrical connector associated with the electrical fixture 114 of the electrical adapter systems 110 of FIGS. 2A-2C. Similarly, the second component 202b of the correlated magnetic electrical connector of the exemplary adapter 124 can connect to the first component 202a of the correlated magnetic electrical connector of the electrical adapter 112 of the electrical adapter systems 110 of FIGS. 2A-2C. Moreover, multiple stackable adapters 124 can be daisy-chained between an electrical fixture 114 and electrical adapter 112 of an electrical adapter system 110 in accordance with the present invention, whereby the first component 202a of the correlated magnetic electrical connector of the a first stackable adapter 124 will connect to the second component 202b of the correlated magnetic electrical connector of the second stackable adapter 124, and so on.

FIG. 2E depicts an exemplary stackable adapter 124 that can be used with the two exemplary components 202a 202b of the correlated magnetic electrical connector of FIG. 2B. In a manner similar to what has been described in relation to FIG. 2D, one or more stackable adapters 124 such as depicted in FIG. 2E can reside between the electrical adapter 112 and electrical fixture 114 of the electrical adapter systems 110 of FIGS. 2A or 2B.

FIG. 2F depicts an exemplary stackable adapter 124 that can be used with the two exemplary components 202a 202b of the correlated magnetic electrical connector of FIG. 2C. In a manner similar to what has been described in relation to FIG. 2D, one or more stackable adapters 124 such as depicted in FIG. 2F can reside between the electrical adapter 112 and electrical fixture 114 of the electrical adapter systems 110 of FIGS. 2A or 2C. An alternative stackable adapter 124 (not shown) could have exemplary components 202a 202b of a correlated magnetic electrical connector that both function as female portions of a male-female connector that could be used with the electrical adapter system 110 of FIG. 2A.

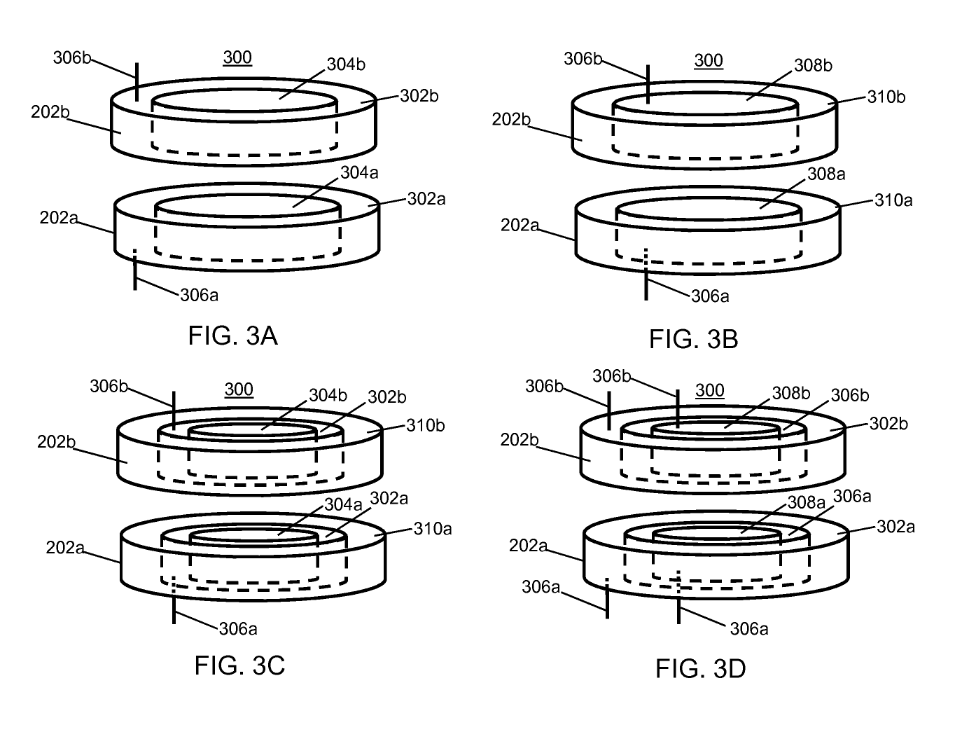

FIG. 3A depicts exemplary ring-shaped electrical contact portions 302a 302b and exemplary circularly-shaped correlated magnetic structure portions 304a 304b of two exemplary components 202a 202b of a correlated magnetic electrical connector 300 in accordance with the present invention. As shown, electrical cables 306a 306b are connected to the ring-shaped electrical contact portions 302a 302b, respectively.

FIG. 3B depicts exemplary circularly-shaped electrical contact portions 308a 308b and exemplary ring-shaped correlated magnetic structure portions 310a 310b of two exemplary components 202a 202b of a correlated magnetic electrical connector 300 in accordance with the present invention. As shown, electrical cables 306a 306b are connected to the circularly-shaped electrical contact portions 308a 308b, respectively.

FIG. 3C depicts exemplary ring-shaped electrical contact portions 302a 302b and exemplary circularly-shaped 304a 304b and ring-shaped 310a 310b correlated magnetic structure portions of two exemplary components 202a 202b of a correlated magnetic electrical connector 300 in accordance with the present invention. As shown, electrical cables 306a 306b are connected to the ring-shaped electrical contact portions 302a 302b, respectively.

FIG. 3D depicts exemplary ring-shaped electrical contact portions 306a 306b and circularly-shaped electrical contact portions 302a 302b and exemplary ring-shaped correlated magnetic structure portions 306a 306b of two exemplary components 202a 202b of a correlated magnetic electrical connector 300 in accordance with the present invention. As shown, electrical cables 306a 306b are connected to the ring-shaped electrical contact portions 302a 302b, respectively, and to the circularly-shaped electrical contact portions 308a 308b, respectively.

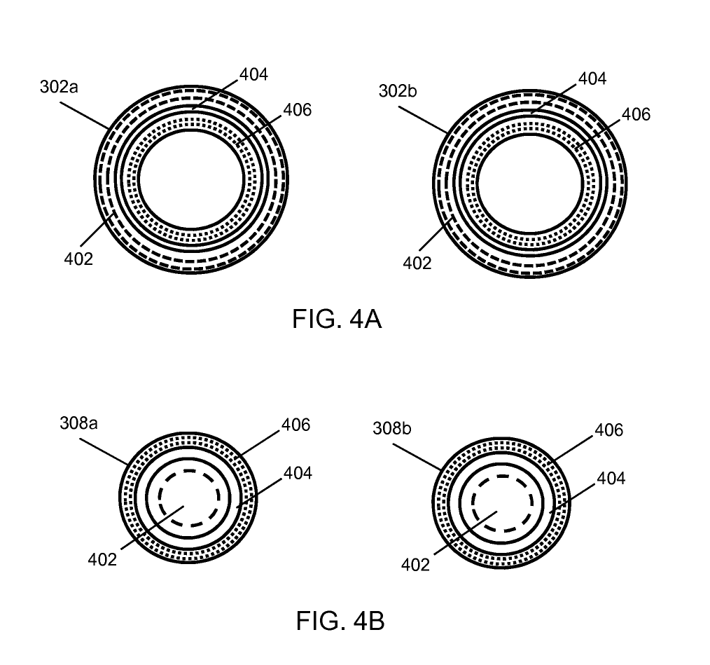

FIG. 4A depicts exemplary electrical contacts 402 404 406 of exemplary ring-shaped electrical portions of two exemplary components 302a 302b of a correlated magnetic electrical connector 300 in accordance with the present invention. As shown in FIG. 4A, outermost ring-shaped electrical portions 402 indicated by two dashed circular lines surround middle ring-shaped electrical portions 404 indicated by two solid circular lines that surround the innermost ring-shaped electrical portions 406 indicated by two dotted circular lines. As such, when the two components 302a 302b are aligned and in contact, there corresponding electrical contact portions 402 404 406 become in contact providing three separate electrical connections, which could be used for example for power, ground, and communications. Generally, to practice the invention, at least two electrical contact portions are required to provide power and ground connectivity but one or more additional electrical contact portions can also be used for other purposes (e.g., for communications, to provide a control signal, or to provide a data signal). Communications connectivity may be used, for example, to identify to an electrical adapter the type of electrical fixture that has been connected to it (or vice versa), to provide sensor information, to provide control signals, etc. Alternatively, two or more electrical contact portions could be used to provide two or more different types of electrical power (e.g., different voltages).

FIG. 4B depicts exemplary electrical contacts of exemplary circularly-shaped electrical portions of two exemplary components of a correlated magnetic electrical connector in accordance with the present invention. As with the electrical contacts of FIG. 4A, three different contact portions 402 404 406 are shown, which might correspond (in no particular order) to communications, power, and ground. As described in relation to FIG. 4A, all sorts of combinations are possible including multiple power connections for supplying different voltages, and so forth.

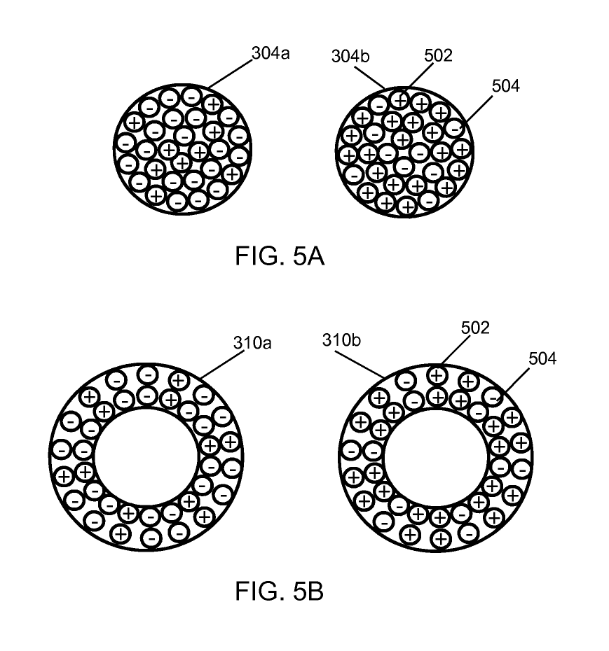

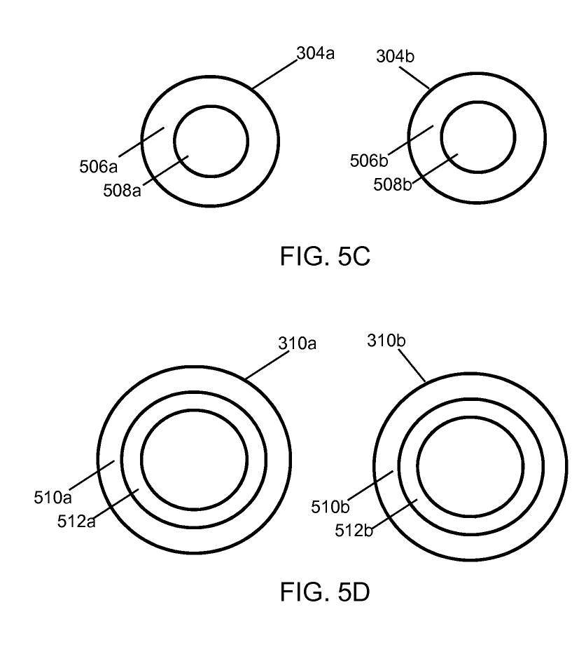

FIG. 5A depicts exemplary circularly-shaped complementary correlated magnetic structure portions 304a 304b of two exemplary components of a correlated magnetic electrical connector 300 in accordance with the present invention. As shown in FIG. 5A, the correlated magnetic structure portions 304a 304b have complementary (i.e., mirror image) patterns of positive maxels 502 and negative maxels 504. The specific patterns used for the magnetic structure portions 304a 304b of a correlated magnetic electrical connector 300 can be selected to have only one rotational alignment where the maxels will all correlate. Alternatively, they may be coded to allow several different correlated positions (e.g., every 60 degrees). The coding pattern used in FIG. 5A comprises three concentric circles of maxels with the outer circle corresponding to four Barker 4 code modulos, the middle circle corresponding to two Barker 5 code modulos, and the innermost circle corresponding to a complementary Barker 4 code modulo.

FIG. 5B depicts exemplary ring-shaped complementary correlated magnetic structure portions 310a 310b of two exemplary components of a correlated magnetic electrical connector 300 in accordance with the present invention. As shown in FIG. 5B, the correlated magnetic structure portions 310a 310b have complementary (i.e., mirror image) patterns of positive maxels 502 and negative maxels 504. As with the correlated magnetic portions 304a 304b of FIG. 5A, the specific patterns used for the magnetic structure portions 310a 310b of a correlated magnetic electrical connector 300 of FIG. 5B can be selected to have only one rotational alignment where the maxels will all correlate or they may be coded to allow several different fully or partially correlated positions. The coding may cause certain rotational alignments where a repel force is produced. Generally, all sorts of magnetic behaviors can be prescribed using correlated magnetics coding techniques. The coding pattern used in FIG. 5B comprises two concentric circles of maxels oriented in a radial pattern, where the two concentric circles each correspond to six code modulos of a Barker 3 code.

FIGS. 5C and 5D are representative of the use of multi-level correlated magnetic structures as the correlated magnetic structure portions of a correlated magnetic electrical connector. Multi-level correlated magnetic structures are described in U.S. patent application Ser. No. 12/885,450, filed Sep. 18, 2010, which is incorporated herein by reference. Generally, such multi-level correlated structures have first and second regions the produce different force vs. distance characteristics that combine to cause magnetic forces that transition from an attract state to a repel state depending on the distance the structures are separated.

FIG. 5C depicts exemplary circularly-shaped multi-level correlated magnetic structure portions 304a 304b of two exemplary components of a correlated magnetic electrical connector 300 in accordance with the present invention. As shown, the first circularly-shaped multi-level correlated magnetic structure portion 304a comprises a first region 506a and a second region 508a and the second circularly-shaped multi-level correlated magnetic structure portion 304b also comprises a first region 506b and a second region 508b that interact with the two regions 506a 508a of the first circularly-shaped multi-level correlated magnetic structure portion 304a to produce multi-level magnetism. As shown, the two first regions 506a 506b are ring-shaped and the second regions 508a 508b are circularly-shaped. Many other shapes of two or more regions could also be employed to produce multi-level magnetism.

FIG. 5D depicts exemplary ring-shaped multi-level correlated magnetic structure portions of two exemplary components of a correlated magnetic electrical connector in accordance with the present invention. As shown, the first ring-shaped multi-level correlated magnetic structure portion 310a comprises a first region 510a and a second region 512a and the second ring-shaped multi-level correlated magnetic structure portion 310b also comprises a first region 510b and a second region 512b that interact with the two regions 510a 512a of the first ring-shaped multi-level correlated magnetic structure portion 310a to produce multi-level magnetism. As shown, the two first regions 510a 512b are ring-shaped and the second regions 510a 512b are ring-shaped. Many other shapes of two or more regions could also be employed to produce multi-level magnetism.

Although, the exemplary connectors and associated magnetic structures have been described herein as being circularly-shaped and ring-shaped, one skilled in the art will recognize that other shapes including square, rectangular, or any other desired shape could be employed in accordance with the invention.

While particular embodiments of the invention have been described, it will be understood, however, that the invention is not limited thereto, since modifications may be made by those skilled in the art, particularly in light of the foregoing teachings.

1. An electrical adapter, the adapter comprising:
an Edison screw base configured to receive a primary voltage from a voltage source;
a voltage converter circuit configured to convert the primary voltage to the secondary voltage; and
a first electrical connector part configured to be detachably coupled to a second electrical connector part of an electrical fixture configured to be powered by the secondary voltage.

2. The electrical adapter of claim 1, wherein the primary voltage is greater than the secondary voltage.

3. The electrical adapter of claim 1, wherein at least one of the first electrical connector part or the second electrical connector part serves as a male portion, and the other electrical connector part serves as a female portion.

4. The electrical adapter of claim 1, wherein the primary voltage is applied to the electrical adapter when the Edison screw base is screwed into an Edison screw socket.

5. The electrical adapter of claim 1, wherein said first electrical connector part comprises:
a first contact portion configured to provide power to the electrical fixture;
a second contact portion configured to provide ground to the electrical fixture; and
a third contact portion configured to provide at least one of a control signal or a data signal to the electrical fixture.

6. The electrical adapter of claim 1, wherein said electrical adapter further comprises an electrical socket that outputs a voltage based on the primary voltage.

7. The electrical adapter of claim 1, wherein said first electrical connector part comprises a first magnetic structure having a plurality of emission sources with polarities positioned according to a first pattern and the second electrical connector part comprises a second magnetic structure having a plurality of emissions sources with polarities positioned according to a second pattern, wherein the second pattern has a complementary correlation to the first pattern.

8. The electrical adapter of claim 7, wherein the first magnetic structure and the second magnetic structure are configured to have a fixed position when magnetically aligned.

9. The electrical adapter of claim 8, wherein the first magnetic structure and the second magnetic structure are configured to be movable within a bounded area when magnetically aligned.

10. The electrical adapter of claim 9, wherein the first electrical connector part comprises a mechanical lock configured to lock and unlock the second electrical connector part in place relative to the first electrical connector part.

11. The electrical adapter of claim 7, wherein the first magnetic structure comprises a first coding pattern and the second magnetic structure comprises a second coding pattern having one or more fully or partially correlated positions with the first coding pattern.

12. The electrical adapter of claim 7, wherein the first magnetic structure and the second magnetic structure comprise multi-level correlated magnetic structures.

13. The electrical adapter of claim 1, wherein said electrical fixture comprises a light emitting diode lamp, wherein the voltage converter circuit enables variation of the secondary voltage to control brightness and power consumption of the light emitting diode lamp.

14. The electrical adapter of claim 1, wherein the first electrical connector part is further configured to be detachably coupled to a stackable electrical adapter comprising:
a third electrical connector part configured to be detachably coupled to the first part electrical connector of the electrical adapter; and
a fourth electrical connector part configured to be detachably coupled to the second electrical connector part of the electrical fixture.

15. An electrical system, comprising:
an electrical adapter comprising:
an Edison screw base configured to receive a primary voltage from a voltage source; and
a voltage converter circuit configured to convert the primary voltage to the secondary voltage; and
an electrical fixture configured to be powered by the secondary voltage,
wherein the electrical adapter is configured to be electrically connected to the electrical fixture using a two part electrical connector.

16. The electrical system of claim 15, wherein the two part electrical connector comprises a first electrical connector part and a second electrical connector part, wherein the electrical adapter further comprises the first electrical connector part and the electrical fixture comprises the second electrical connector part.

17. The electrical adapter of claim 15, wherein said first electrical connector part comprises a first magnetic structure having a plurality of emission sources with polarities positioned according to a first pattern and the second electrical connector part comprises a second magnetic structure having a plurality of emissions sources with polarities positioned according to a second pattern, wherein the second pattern has a complementary correlation to the first pattern.

18. The electrical adapter of claim 17, wherein the first magnetic structure and the second magnetic structure are configured to have a fixed position when magnetically aligned.

19. The electrical adapter of claim 17, wherein the first magnetic structure and the second magnetic structure are configured to be movable within a bounded area when magnetically aligned.

20. The electrical adapter of claim 19, wherein the first electrical connector part comprises a mechanical lock configured to lock and unlock the second electrical connector part in place relative to the first electrical connector part.

21. The electrical adapter of claim 17, wherein the first magnetic structure comprises a first coding pattern and the second magnetic structure comprises a second coding pattern having one or more fully or partially correlated positions with the first coding pattern.

22. The electrical adapter of claim 17, wherein the first magnetic structure and the second magnetic structure comprise multi-level correlated magnetic structures.
